(19) United States
(12) Patent Application Publication
(10) Pub. No.: US 2008/0176078 A1
(43) Pub. Date: Jul. 24, 2008

(54) SHEET FOR PROTECTING COATING LAYER

(75) Inventor: Atsuhiro TANAKA, Saitama (JP)

Correspondence Address: OBLON, SPIVAK, MCCLELLAND MAIER & NEUSTADT, P.C., 1940 DUKE STREET, ALEXANDRIA, VA, 22314, US

(73) Assignee: LINTEC CORPORATION, Itabashi-ku (JP)

(21) Appl. No.: 11/679,431

(22) Filed: Feb. 27, 2007

(30) Foreign Application Priority Data
Feb. 28, 2006 (JP) 2006-053915

(51) Int. Cl. B32B 27/30

(52) U.S. Cl. 428/411.1

(57) ABSTRACT

Provided is a protective sheet for a coating layer comprising a substrate sheet having a pressure-sensitive adhesive layer, capable of being applied as well to a coated surface which is insufficiently cured immediately after drying, wherein a pressure-sensitive adhesive constituting the pressure-sensitive adhesive layer described above comprises a resin obtained by cross-linking a copolymer having unsaturated groups on side chains through irradiating with an energy beam, and the copolymer described above comprises at least one selected from butyl(meth)acrylate, 2-ethylhexyl(meth)acrylate and isooctyl(meth)acrylate as a monomer component.

### BACKGROUND OF THE INVENTION

1. Field of the Invention

The present invention relates to a protective sheet for a coating layer, more specifically to a protective sheet for a coating layer which does not allow coating layers applied on automobile bodies and parts of automobiles to change in quality or color and which is excellent in a peeling property after adhered for a long period of time.

The protective sheet for a coating layer according to the present invention is a protective sheet capable of being applied as well to a coating layer of a urethane-based coating material in which a small amount of a solvent remains due to inadequate drying and which is insufficiently cured after drying, and it is particularly useful as a protective sheet for coated plastic-made parts such as a bumper and the like.

2. Description of the Related Art

When transporting automobiles, brought about are the inconveniences that the coating layers of automobile bodies and parts become lusterless or discolored due to suspended matters such as dirts and dusts, rain, grass pollen and the like, colliding matters such as sands and the like and contact by workers. In order to prevent such inconveniences, wax-based materials are applied on the coating layers of automobile bodies and parts of automobiles, or protective sheets are adhered thereon.

However, in heating and curing coating layers applied on automobile bodies and parts, the curing reaction of the coating layers does not sufficiently proceed in a certain case even after passing through a drying furnace.

Among them, in the case of a bumper which is one of parts for automobiles, synthetic resin-made bumpers have come to be used in place of conventional metal-made ones in order to reduce a weight thereof, and the above synthetic resin-made bumpers are usually coated in order to improve its appearance. In the case of the above synthetic resin-made bumpers, protective sheets are adhered thereon as well in order to prevent the inconveniences described above.

However, in heating and curing coating layers applied on synthetic resin-made bumpers, the curing temperature can not be elevated in order to avoid adverse affections such as deterioration and deformation of the resins. Accordingly, the coating layers on the coated synthetic resin-made bumpers are insufficiently dried even after passing through a drying furnace, and therefore a small amount of the solvent remains or the curing reaction does not sufficiently proceed in a certain case.

When adhering a protective sheet on a coating layer in such state, brought about are problems such as “stepping (the phenomenon that deformations brought about by fine wrinkles and lifting produced on the sheet in adhering the protective sheet are transferred onto the coating layer, whereby the coating layer is deformed)”, “whitening (the phenomenon that deviation is caused in the composition of the coating layer due to compatibility thereof with a pressure-sensitive adhesive layer of the sheet and that the coating layer looks white when peeling the sheet)” and “adhesive deposit (the phenomenon that the adhesive is partially transferred onto the coating layer when peeling the sheet)”.

Proposed as a protective sheet for a coating layer are a sheet prepared by providing a layer of a polyisobutylene-based pressure-sensitive adhesive on a substrate for supporting (for example, a Patent Document 1), a sheet prepared by providing a layer of a pressure-sensitive adhesive comprising butyl rubber or styrene-ethylene-butylene-styrene block copolymer on a substrate for supporting (for example, a Patent Document 2), a sheet prepared by providing a layer of a composition obtained by mixing a polyisobutylene-based pressure-sensitive adhesive with a small amount of an acrylic-based pressure-sensitive adhesive on a substrate for supporting (for example, a Patent Document 3), a sheet prepared by providing a layer of a composition obtained by blending an acrylic-based pressure-sensitive adhesive with a multifunctional isocyanate compound on a substrate for supporting (for example, a Patent Document 4), a sheet prepared by providing an ethylene-vinyl acetate-glycidyl methacrylate copolymer on a substrate for supporting (for example, a Patent Document 5) and a sheet prepared by providing on a substrate for supporting, a pressure-sensitive adhesive layer obtained by photo-curing a resin comprising a principal component of an ionomer obtained by subjecting an ethylene-methacrylic acid copolymer to intermolecular bonding with metal ions (for example, a Patent Document 6).

Further, proposed is a sheet prepared by providing on a substrate for supporting, a pressure-sensitive adhesive layer obtained by cross-linking a resin composition comprising urethane (meth)acrylate having a hydrogenated polybutadiene skeleton and alkyl (meth)acrylate having 6 or more carbon atoms with an active energy beam (for example, a Patent Document 7).

However, the performances of the protective sheets for a urethane-based coating layer for automobiles which have the pressure-sensitive adhesive layer described above are not still satisfactory.

Patent Document 1: U.S. Pat. No. 2,701,020
Patent Document 2: U.S. Pat. No. 3,668,322
Patent Document 3: U.S. Pat. No. 2,832,565
Patent Document 4: U.S. Pat. No. 3,342,977

### Patent Document 5: JP 1998-121002A

### Patent Document 6: JP 1998-121010A

### Patent Document 7: JP 2002-309185A

### SUMMARY OF THE INVENTION

In light of the situation described above, an object of the present invention is to solve the problems described above in a protective sheet for a coating layer by using a pressure-sensitive adhesive comprising an acrylic-based resin component having a pressure-sensitive adhesive property which is developed by cross-linking.

Intensive researches repeated by the present inventors have resulted in finding that the above object can be achieved by using a protective sheet prepared by applying on a substrate sheet, a pressure-sensitive adhesive layer comprising a resin in which a pressure-sensitive adhesive property is developed by cross-linking a copolymer having unsaturated groups on side chains, and thus the present inventor has completed the present invention.

That is, the present invention provides the following items (1) to (15):

(1) A protective sheet for a coating layer comprising a substrate sheet having a pressure-sensitive adhesive layer, wherein a pressure-sensitive adhesive constituting the pressure-sensitive adhesive layer comprises a resin obtained by cross-linking of a copolymer having unsaturated groups on side chains through irradiating with an active energy beam, and the copolymer comprises at least one selected from butyl (meth)acrylate, 2-ethylhexyl (meth)acrylate and isooctyl (meth)acrylate as a monomer component
(2) The protective sheet as described in the above item (1), wherein the copolymer is a copolymer of butyl acrylate,
(3) The protective sheet as described in the above item (1), wherein the copolymer is a n-butyl acrylate-methyl acrylate copolymer,
(4) The protective sheet as described in the above item (1), wherein the copolymer has a weight average molecular weight of 200,000 to 2,000,000,
(5) The protective sheet as described in the above item (2), wherein the copolymer has a weight average molecular weight of 200,000 to 2,000,000,
(6) The protective sheet as described in the above item (3), wherein the copolymer has a weight average molecular weight of 200,000 to 2,000,000,
(7) The protective sheet as described in the above item (1), wherein the copolymer has on a principal chain, a structural unit originating in a polymerizable monomer having a hydroxyl group or a carboxyl group, and the unsaturated group is an unsaturated group originating in a monoisocyanate compound having an unsaturated group,
(8) The protective sheet as described in the above item (2), wherein the copolymer has on a principal chain, a structural unit originating in a polymerizable monomer having a hydroxyl group or a carboxyl group, and the unsaturated group is an unsaturated group originating in a monoisocyanate compound having an unsaturated group,
(9) The protective sheet as described in the above item (3), wherein the copolymer has on a principal chain, a structural unit originating in a polymerizable monomer having a hydroxyl group or a carboxyl group, and the unsaturated group is an unsaturated group originating in a monoisocyanate compound having an unsaturated group,
(10) The protective sheet as described in the above item (1), wherein it is a protective sheet for a coating layer for applying on automobiles,
(11) The protective sheet as described in the above item (2), wherein it is a protective sheet for a coating layer for applying on automobiles,
(12) The protective sheet as described in the above item (3), wherein it is a protective sheet for a coating layer for applying on automobiles,
(13) The protective sheet as described in the above item (1), wherein it is a protective sheet for a urethane-based coating layer for applying on resin-made bumpers,
(14) The protective sheet as described in the above item (2), wherein it is a protective sheet for a urethane-based coating layer for applying on resin-made bumpers and
(15) The protective sheet as described in the above item (3), wherein it is a protective sheet for a urethane-based coating layer for applying on resin-made bumpers.

According to the present invention, capable of being provided is a protective sheet for a coating layer which is less liable to allow coating layers applied on automotive bodies and parts of automobiles to change in quality or color and which is excellent in a peeling property after adhered for a long period of time. In particular, it is useful as a protective sheet for coating layers in which a small amount of a solvent remains due to insufficient drying immediately after drying in plastic-made parts such as coated bumpers and the like and in which an isocyanate group and the like remain due to insufficient curing.

### DETAILED DESCRIPTION OF THE INVENTION

A pressure-sensitive adhesive constituting the pressure-sensitive adhesive layer provided on the protective sheet for a coating layer according to the present invention comprises a resin obtained by cross-linking of a copolymer having unsaturated groups on side chains through irradiating with an active energy beam.

The copolymer having unsaturated groups on side chains can be prepared, for example, in the following manner.

First, radically copolymerized are at least one selected from butyl (meth)acrylate, 2-ethylhexyl (meth)acrylate and isooctyl (meth)acrylate, a polymerizable monomer having active hydrogens such as hydroxyethyl acrylate and acrylic acid and, if necessary, other polymerizable monomers having no active hydrogens, whereby obtained is a copolymer having a skeleton originating in the respective polymerizable monomers described above on a principal chain and having active hydrogens on side chains.

Then, an isocyanate group in a monoisocyanate compound having a (meth)acryloyl group is allowed to react with active hydrogens on side chain of the above copolymer, whereby a copolymer having unsaturated groups [a (meth)acryloyl group] on side chains can be obtained, and a pressure-sensitive adhesive can be prepared by cross-linking of the above copolymer through irradiating with an active energy beam.

Available as well is a method in which a polymerizable monomer having active hydrogens such as hydroxyethyl acrylate and acrylic acid is first allowed to react with a monoisocyanate compound having a (meth)acryloyl group and in which the resulting compound having (meth)acryloyl groups at both sides is used as a polymerizable monomer and radically copolymerized. In this case, however, the (meth)acryloyl group at one side has to be masked so that gelation is not brought about in the copolymerization.

Either of n-butyl or isobutyl(meth)acrylate can be used as butyl(meth)acrylate.

The polymerizable monomer having active hydrogens includes compounds having a hydroxyl group, a carboxyl group, an amino group, an epoxy group and the like as a functional group.

The polymerizable monomer having a hydroxyl group includes hydroxyalkyl(meth)acrylates such as hydroxymethyl(meth)acrylate, hydroxyethyl(meth)acrylate, hydroxypropyl(meth)acrylate, hydroxybutyl(meth)acrylate and the like. The above hydroxyalkyl(meth)acrylates may be used in the form of a mixture of two or more kinds thereof.

Polymerizable monomers having a hydroxyl group other than the hydroxyalkyl(meth)acrylates include (meth)acrylate monools, and to be specific, they include ethyleneglycol mono(meth)acrylate, propyleneglycol mono(meth)acrylate, tetramethyleneglycol mono(meth)acrylate, neopentylglycol mono(meth)acrylate, trimethylolpropane di(meth)acrylate, pentaerythritol tri(meth)acrylate and the like. The above (meth)acrylates may be used in the form of a mixture of two or more kinds thereof.

Polymerizable monomers having active hydrogens other than the compounds described above include compounds having a carboxyl group such as unsaturated carboxylic acids including acrylic acid, methacrylic acid, maleic acid, fumaric acid, itaconic acid and the like. The compounds having an amino group include monomethylaminoethyl(meth)acrylate, monoethylaminoethyl(meth)acrylate, acrylamide and methacrylamide. The compounds having an epoxy group include glycidyl(meth)acrylate, 3,4-cyclohexymethyl(meth)acrylate, lactone-modified 3,4-cyclohexymethyl(meth)acrylate and the like.

Among the polymerizable monomers having active hydrogens described above, hydroxyethyl(meth)acrylate is preferably used from the viewpoints of easiness in availability and a radical polymerizability.

The other polymerizable monomers having no active hydrogens which are used if necessary include (meth)acrylates having aliphatic groups such as methyl (meth)acrylate, ethyl (meth)acrylate, propyl(meth)acrylate, pentyl(meth)acrylate, hexyl(meth)acrylate, decyl(meth)acrylate, isodecyl(meth)acrylate, lauryl(meth)acrylate, butoxyethyl(meth)acrylate and the like, (meth)acrylates having aromatic groups such as benzyl(meth)acrylate and the like, (meth)acrylates having alicyclic groups such as cyclohexyl(meth)acrylate and the like, acrylonitrile and vinyl esters such as vinyl acetate, vinyl butyrate and the like.

A copolymerization ratio of at least one of the three monomer components such as butyl(meth)acrylate and the like described above to the polymerizable monomer having active hydrogens is 0.1 to 50 moles, preferably 1 to 10 moles for the latter based on 100 moles for the former.

A copolymerization ratio of the polymerizable monomer having active hydrogens makes it possible to control a content of unsaturated groups on side chains.

Setting the copolymerization ratio to 0.1 mole or more makes it possible to control a content of unsaturated groups on side chains to 0.1 mole or more and allows a cohesion (holding power) to develop in the resulting copolymer through irradiating with an active energy beam. On the other hand, setting the copolymerization ratio to 50 moles or less controls a content of unsaturated groups on side chains to 50 moles or less and prevents the pressure-sensitive adhesive property from being too small and a flexibility of the pressure-sensitive adhesive layer from being lost.

A copolymerization ratio of at least one of the three monomer components such as butyl (meth)acrylate and the like described above to the other polymerizable monomers having no active hydrogens is 0 to 50 moles, preferably 0 to 10 moles for the latter based on 100 moles for the former. Setting the copolymerization ratio to the range described above makes it possible to maintain a glass transition temperature of the resulting copolymer in a suitable range and makes it possible to minimize an effect exerted on a urethane-based coating layer by a pressure-sensitive adhesive layer comprising a resin obtained by cross-linking a copolymer in which active hydrogens on side chains are modified to an unsaturated group through irradiating with an active energy beam, so that an adverse affection is prevented from being exerted on the coating layer.

A conventional radical polymerization method which has so far been carried out can be applied to the production of the copolymer.

For example, the monomers described above are dissolved in a hydrocarbon-based organic solvent such as toluene and xylene or an ester-based organic solvent such as ethyl acetate each having no active hydrogens, and the solution is mixed with a polymerization initiator such as azobisisobutyronitrile, azobisisovaleronitrile and benzoyl peroxide and heated at about 50 to 90° C. for about 3 to 20 hours in a refluxing state, whereby an organic solvent solution of a copolymer is obtained.

Bulk polymerization may be carried out using only the polymerizable monomer and the polymerization initiator without using the organic solvent. When the copolymer is obtained in the form of an organic solvent solution, it may be reacted as it is with a monoisocyanate compound having a (meth)acryloyl group or a part or a whole amount of the organic solvent may be removed, and then a fresh organic solvent of a hydrocarbon base or an ester base which is inactive to an isocyanate group may be added thereto to carry out reaction.

The above reaction is reaction of a hydroxyl group or a carboxyl group with an isocyanate group, and it is continuously carried out in a temperature range of usually 10 to 100° C., preferably 30 to 90° C. for about 1 to 10 hours using a conventional urethane catalyst such as dibutyltin dilaurate and dibutyltin diethylhexanoate.

An amount to be used of the urethane catalyst is usually 50 to 1000 ppm, preferably 50 to 500 ppm based on the total mass of the raw materials used for the reaction, but an amount to be used of the urethane catalyst is preferably smaller from the viewpoint of reducing an effect exerted on a coating layer after adhering the protective sheet of the present invention on the coating layer and peeling it therefrom.

The copolymer has a weight average molecular weight of usually 200,000 or more, preferably 400,000 to 2,000,000 and more preferably 500,000 to 1,000,000.

In addition to the copolymer having unsaturated groups on side chains described above, various additives can be added as optional components to the pressure-sensitive adhesive in the present invention as long as characteristics required to the protective sheet for a coating layer are not damaged. The additives include antioxidants, light stabilizers of a benzotriazole-based, flame retardants of a phosphoric ester base and others, antistatic agents such as cationic surfactants, inert solvents such as toluene and xylene which are used in order to reduce a viscosity when applying the pressure-sensitive adhesive, colorants and fillers.

In the present invention, after the respective components described above are blended, a release sheet is coated with the blended matter and stuck together with a substrate sheet or the substrate sheet is coated with the blended matter and stuck together with the release sheet to prepare a laminate, and then the above laminate is cross-linked through irradiating with an energy beam, whereby a protective sheet for a coating layer having a suited pressure-sensitive adhesive strength and a suited removing property is obtained.

Used as the substrate sheet are films comprising polyolefins such as polyethylene and polypropylene, polyesters such as polyethylene terephthalate and polyethylene naphthalate and resins such as polyimide, polyetherimide, polyaramide, polyetherketone, polyether-etherketone, polyphenylene sulfide and poly(4-methylpentene-1), nonwoven fabrics and synthetic papers. Polyethylene films are preferred from the viewpoints of economical efficiency and easiness in handling.

A thickness of the substrate sheet is somewhat different depending on the materials used, and it is usually about 5 to 300 μm, preferably about 10 to 100 μm. In the case of a polyethylene film which is one of the preferred substrate sheets, the thickness is preferably about 10 to 50 μm.

The composition used for preparing the pressure-sensitive adhesive can be applied on the release sheet or the substrate sheet by a gravure coating method, a bar coating method, a spray coating method, a spin coating method, a roll coating method, a die coating method, a knife coating method, an air knife coating method, a hot melt coating method, a curtain coating method and the like which are usually carried out.

A thickness of the pressure-sensitive adhesive layer after drying which is formed on the release sheet or the substrate sheet is usually about 1 to 50 μm, preferably about 5 to 30 μm. Controlling a thickness of the pressure-sensitive adhesive layer to 1 μm or more makes it possible to secure a pressure-sensitive adhesive strength and a cohesive strength (holding power) which are required to the protective sheet for a coating layer, and controlling it to 50 μm or less avoids an increase in the cost and prevents the pressure-sensitive adhesive layer from protruding from the ends.

A pressure-sensitive adhesive layer is formed on a release sheet or a substrate sheet, and after it is cured through irradiating with an energy beam, both are stuck together, or a pressure-sensitive adhesive layer is formed on a release sheet or a substrate sheet, and both are stuck together to prepare a laminate, followed by cross-linking it through irradiating with an energy beam, whereby the protective sheet for a coating layer according to the present invention having a suited pressure-sensitive adhesive strength and a suited removing property is obtained.

The energy beam means beams having an energy quantum among electromagnetic waves and charged particle beams, that is, an active light such as a UV ray or an electron beam. When cross-linking is carried out through irradiating with an electron beam, a photopolymerization initiator is not required, but when cross-linking is carried out through irradiating with an active light such as a UV ray, a photopolymerization initiator is preferably allowed to be present.

The photopolymerization initiator used when irradiated with a UV ray shall not specifically be restricted, and optional photopolymerization initiators suitably selected from photopolymerization initiators which have so far been conventionally used for UV ray-curing type resins can be used. The above photopolymerization initiator includes, for example, benzoins, benzophenones, acetophenones, α-hydroxyketones, α-aminoketones, α-diketones, α-diketone dialkylacetals, anthraquinones, thioxanthones and other compounds.

The above photopolymerization initiators may be used alone or in combination of two or more kinds thereof. An amount to be used thereof is selected in a range of usually 0.01 to 30 parts by mass, preferably 0.05 to 20 parts by mass based on 100 parts by mass of the copolymer having unsaturated groups on side chains.

The protective sheet for a coating layer having a suited pressure-sensitive adhesive strength and a suited removing property is obtained by cross-linking through irradiating with an active energy beam.

An accelerating voltage of an electron beam which is one of active energy beams in carrying out cross-linking through irradiating with the electron beam is usually 130 to 300 kV, preferably 150 to 250 kV. Irradiation at an accelerating voltage of 130 kV or more makes it possible to prevent the pressure-sensitive adhesive strength from being unsatisfactory due to insufficient cross-linking, and irradiation at an accelerating voltage of 300 kV or less makes it possible to prevent the pressure-sensitive adhesive layer and the substrate sheet from being deteriorated or discolored.

A dosage of the electron beam to be irradiated is preferably 1 to 70 Mrad, more preferably 2 to 20 Mrad. Irradiation at a dosage of 1 Mrad or more makes it possible to prevent the pressure-sensitive adhesive layer and the substrate sheet from being deteriorated or discolored and prevent the pressure-sensitive property from being unsatisfactory due to insufficient cross-linking. Irradiation at a dosage of 70 Mrad or less makes it possible to prevent the cohesive strength from being reduced by deterioration or discoloration of the pressure-sensitive adhesive layer and prevent the substrate sheet from being deteriorated or shrunk.

A dosage in the case of irradiating with a UV ray is suitably selected. A light quantity thereof is 100 to 500 mJ/cm², and an illuminance thereof is 10 to 500 mW/cm².

Irradiation with an active energy beam is preferably carried out under nitrogen atmosphere in order to prevent the reaction from being disturbed by oxygen.

As described above, the stable pressure-sensitive adhesive strength and the suited removing property are provided by cross-linking through irradiating with an active energy beam.

The substrate sheet is preferably subjected to corona discharge treatment and/or ozone treatment before the substrate sheet is adhered onto the surface of the pressure-sensitive adhesive layer applied on the release sheet or before applying the pressure-sensitive adhesive on the substrate sheet in order to strengthen a close adhesiveness between the pressure-sensitive adhesive layer and the substrate sheet from the viewpoint of preventing the “adhesive deposit” phenomenon that the pressure-sensitive adhesive layer is partially transferred onto the coating layer when peeling the protective sheet for a coating layer according to the present invention from the coated surfaces of automobile bodies and parts of automobiles.

Capable of being used as the release sheet are resin films of polyethylene terephthalate, polyethylene, polypropylene and the like which are coated with a releasing agent such as a fluorine-based resin, a silicone-based resin, long chain alkyl group-containing carbamate and the like.

A thickness of the release sheet is somewhat different depending on the materials used, and it is usually 10 to 250 μm, preferably 20 to 200 μm.

### EXAMPLES

Hereinafter, the present invention is explained in further details with reference to examples and comparative examples, but the present invention shall by no means be restricted by these examples.

### Example 1

A polyethylene film (a trade name: PE Wadatoumei 50ASKAI4 manufactured by J-Film Corporation) having a thickness of 50 μm which was blended with an antistatic agent was used as a substrate sheet for the protective sheet, and a polyethylene terephthalate film (SP-PET3801 manufactured by Lintec Corporation) having a thickness of 38 μm which was coated with a silicone-based resin was used as a release sheet. A solution of a copolymer for forming a pressure-sensitive adhesive layer was prepared in the following manner.

Dissolved in 150 parts by mass of toluene was 100 parts by mass of a copolymer (BA/HEA mole ratio 100/5, a weight average molecular weight: 600,000) of butyl acrylate (BA) with hydroxyethyl acrylate (HEA) prepared by the radical polymerization method described above. Then, 0.5 part by mass of 2-methacryloyloxyethyl isocyanate and 0.01 part by mass of dibutyltin dilaurate as a catalyst were added thereto, and the solution was heated at 50° C. to carry out reaction for 7 hours, whereby a toluene solution of a copolymer having acryloyl groups on side chains was prepared.

Irgacure 184 (an acetophenone-based compound manufactured by Ciba Specialty Chemicals K. K.) 3.5 parts by mass as a photopolymerization initiator was added to 100 parts by mass of the above solution, and then ethyl acetate was added thereto to dilute the solution to a solid matter concentration of 30% by mass.

The solution having a solid matter concentration of 30% by mass described above was applied on a silicone resin-coated surface of the release sheet described above by a knife coating method so that a thickness after drying was 20 μm, and it was dried at 100° C. for 1 minute to form a layer which was a pressure-sensitive adhesive layer on the release sheet, followed by sticking the release sheet together with the substrate sheet described above. Then, the release sheet side was irradiated with a UV ray by means of a high pressure mercury lamp to prepare a protective sheet for a coating layer. The dosage was 200 mJ/cm² (365 nm).

### Comparative Example 1

A polyethylene film (a trade name: PE Wadatoumei 50ASKAI4, manufactured by J-Film Corporation) having a thickness of 50 μm which was blended with an antistatic agent was used as a substrate sheet for the protective sheet, and a polyethylene terephthalate film (SP-PET3801, manufactured by Lintec Corporation) having a thickness of 38 μm which was coated with a silicone resin was used as a release sheet.

Used as a pressure-sensitive adhesive was a solution prepared by mixing 100 parts by mass of an acrylic-based pressure-sensitive adhesive obtained by diluting a butyl acrylate-acrylic acid copolymer [butyl acrylate/acrylic acid (mole ratio): 100/10] having a weight average molecular weight of 600,000 to 30% by mass with ethyl acetate and 5 parts by mass of a 5% by mass ethyl acetate solution of 1,3-bis(N,N-diglycidylaminomethyl)cyclohexane as a cross-linking agent.

The above solution was applied on a silicone resin-coated surface of the release sheet described above by a knife coating method so that a thickness after drying was 20 μm and dried at 100° C. for one minute, and then the release sheet was stuck together with the substrate sheet described above to prepare a protective sheet for comparison.

### Comparative Example 2

A protective sheet for comparison was prepared in the same manner as in Comparative Example 1, except that used as a pressure-sensitive adhesive was a solution obtained by diluting a rubber-based pressure-sensitive adhesive comprising a polyisobutylene having a viscosity average molecular weight of 800,000 to 30% by mass with toluene and that the cross-linking agent was not used.

### <Evaluated Items and Methods for Evaluating>

A double liquid type polyurethane-based top coating material for automobiles (prepared by mixing 100 parts by mass of Rock Multi Top Clear SF150-5150 with 50 parts by mass of Rock Multi Top Clear S curing agent standard 150-5120 each manufactured by Rock Paint Co., Ltd.) was sprayed in a thickness of about 1 μm on a plate of a polyolefin-based thermosetting elastomer on which an electrodepositing primer and an intermediate coating material were applied. It was dried at 60° C. for 10 minutes and left standing at room temperature for 30 minutes, and then the respective protective sheets obtained in the examples and the comparative examples which were cut into a tape shape were adhered on the coating layer. The sheets of a tape shape which were adhered on the coated surfaces were left standing at room temperature for 24 hours and then peeled, and the states of the coating layers were visually observed to evaluate the respective characteristics according to the following criteria.

(1) Stepping of a wrinkle part

◯: Step can not be confirmed.

Δ: Step can be confirmed, and a vertical interval of stepping is 0.3 to 1 μm.

X: Step can be confirmed, and a vertical interval of stepping is 1 μm or more.

(2) Boundary between a sheet-adhered part and a none-adhered part

◯: Boundary can not be confirmed.

Δ: Boundary can slightly be confirmed.

X: Boundary can clearly be confirmed.

(3) Whitening of an adhesive contact surface

◯: Whitening can not be confirmed.

Δ: Whitening can be confirmed but can not be confirmed after left standing outdoors for one week.

X: Whitening can be confirmed and can be still confirmed even after left standing outdoors for one week.

(4) Adhesive deposit

◯: Adhesive deposit can not be confirmed on the coated surface.

Δ: Adhesive deposit can slightly be confirmed on the coated surface.

X: Adhesive deposit can notably be confirmed on the coated surface.

TABLE 1

Comparative
Examples

| | Examples 1 | 1 | 2 |
|---|---|---|---|
| Stepping of wrinkle part | ◯ | X | Δ |
| Boundary between sheet- | ◯ | X | Δ |
| adhered part and non | | | |
| adhered part | | | |
| Whitening of adhesive | ◯ | X | Δ |
| contact surface | | | |
| Adhesive deposit | ◯ | X | Δ |

As apparent from the results shown in Table 1, it can be found that the protective sheets for a coating layer according to the present invention obtained in the examples are excellent in all characteristics as compared with those of the protective sheets obtained in the comparative examples.

### INDUSTRIAL APPLICABILITY

The protective sheet for a coating layer according to the present invention can be applied as well to a coating layer of a urethane-based coating material which is insufficiently cured, and it can suitably be used particularly as a protective sheet for coated plastic-made parts such as bumpers and the like.

What is claimed is:

1. A protective sheet for a coating layer comprising a substrate sheet having a pressure-sensitive adhesive layer, wherein a pressure-sensitive adhesive constituting the pressure-sensitive adhesive layer comprises a resin obtained by cross-linking of a copolymer having unsaturated groups on side chains through irradiating with an active energy beam, and the copolymer comprises at least one selected from butyl (meth)acrylate, 2-ethylhexyl (meth)acrylate and isooctyl (meth)acrylate as a monomer component.

2. The protective sheet as claimed in claim 1, wherein the copolymer is a copolymer of butyl acrylate.

3. The protective sheet as claimed in claim 1, wherein the copolymer is a n-butyl acrylate-methyl acrylate copolymer.

4. The protective sheet as claimed in claim 1, wherein the copolymer has a weight average molecular weight of 200,000 to 2,000,000.

5. The protective sheet as claimed in claim 2, wherein the copolymer has a weight average molecular weight of 200,000 to 2,000,000.

6. The protective sheet as claimed in claim 3, wherein the copolymer has a weight average molecular weight of 200,000 to 2,000,000.

7. The protective sheet as claimed in claim 1, wherein the copolymer has on a principal chain, a structural unit originating in a polymerizable monomer having a hydroxyl group or a carboxyl group, and the unsaturated group is an unsaturated group originating in a monoisocyanate compound having an unsaturated group.

8. The protective sheet as claimed in claim 2, wherein the copolymer has on a principal chain, a structural unit originating in a polymerizable monomer having a hydroxyl group or a carboxyl group, and the unsaturated group is an unsaturated group originating in a monoisocyanate compound having an unsaturated group.

9. The protective sheet as claimed in claim 3, wherein the copolymer has on a principal chain, a structural unit originating in a polymerizable monomer having a hydroxyl group or a carboxyl group, and the unsaturated group is an unsaturated group originating in a monoisocyanate compound having an unsaturated group.

10. The protective sheet as claimed in claim 1, wherein it is a protective sheet for a coating layer for applying on automobiles.

11. The protective sheet as claimed in claim 2, wherein it is a protective sheet for a coating layer for applying on automobiles.

12. The protective sheet as claimed in claim 3, wherein it is a protective sheet for a coating layer for applying on automobiles.

13. The protective sheet as claimed in claim 1, wherein it is a protective sheet for a urethane-based coating layer for applying on resin-made bumpers.

14. The protective sheet as claimed in claim 2, wherein it is a protective sheet for a urethane-based coating layer for applying on resin-made bumpers.

15. The protective sheet as claimed in claim 3, wherein it is a protective sheet for a urethane-based coating layer for applying on resin-made bumpers.
